(19) United States
(12) Patent Application Publication
(10) Pub. No.: US 2018/0091016 A1
(43) Pub. Date: Mar. 29, 2018

(54) ELECTRIC COMPRESSOR

(71) Applicant: KABUSHIKI KAISHA TOYOTA JIDOSHOKKI, Kariya-shi (JP)

(72) Inventors: Akio FUJII, Aichi-ken (JP); Shingo ENAMI, Aichi-ken (JP); Junya YANO, Aichi-ken (JP)

(73) Assignee: KABUSHIKI KAISHA TOYOTA JIDOSHOKKI, Kariya-shi (JP)

(21) Appl. No.: 15/715,958

(22) Filed: Sep. 26, 2017

(30) Foreign Application Priority Data
Sep. 29, 2016 (JP) 2016-192014

(51) Int. Cl. H02K 5/22; H02K 5/04; F25B 31/02; F25B 1/04

(52) U.S. Cl. CPC H02K 5/225; F25B 1/04; F25B 31/02; H02K 5/04

(57) ABSTRACT

An electric compressor includes a housing, a compression portion that compresses refrigerant, an electric motor that drives the compression portion through a rotary shaft, a circuit board that drives and controls the electric motor, and a connector that is fixed to the housing and configured to electrically connect an external power source to the circuit board. The connector includes a first terminal portion extending in an axial direction of the rotary shaft and a second terminal portion extending in a radial direction of the housing and having a connecting portion through which the first terminal portion and the second terminal portion are connected to each other. The second terminal portion is adapted to elastically hold the first terminal portion at the connecting portion in such a manner as to permit the first terminal portion to move relative to the second terminal portion in the axial direction of the rotary shaft.

### BACKGROUND OF THE INVENTION

The present invention relates to an electric compressor.

A conventional electric compressor is disclosed in Japanese Unexamined Patent Application Publication No. 2013-160092. The electric compressor of the Publication includes a housing, a compression portion, an electric motor, a circuit board, and a connector. The electric motor has a rotary shaft. The compression portion, the electric motor, and the circuit board are disposed in the housing.

The connector is fixed to the housing. The connector includes a first terminal portion, a second terminal portion, and a metal plate. The first terminal portion is connectable to an external power source provided outside the electric compressor. A conductive member is connected to the second terminal portion, so that the second terminal portion is electrically connected to the circuit board through the conductive member. The metal plate extends in the axial direction of the rotary shaft and is disposed between the first terminal portion and the second terminal portion. One axial end of the metal plate is welded to the first terminal portion and the other axial end of the metal plate is welded to the second terminal portion to form an assembly. In the assembly of the first and second terminal portions and the metal plate, the first and second terminal portions are electrically connectable through the metal plate.

According to the electric compressor of the Publication, by connecting the first terminal portion to the external power source, the connector connects the external power source and the circuit board through the above-described assembly. By virtue of this electrical connection, the rotary shaft of the electric motor is driven and controlled by the circuit board to thereby operate the compression portion. Thus, in the electric compressor, the compression portion compresses refrigerant.

In the electric compressor of the above Publication in which the first and second terminal portions and the metal plate are connected by welding, the connector needs a space that is large enough to permit welding operation with a welding tool, which involves an increase in the size of the metal plate. Due to the increased size of the space in the connector, the size of the connector and hence the electric compressor itself are increased accordingly.

Furthermore, in the electric compressor of the Publication in which the first and second terminal portions and the metal plate are assembled or connected by welding, there may occur variation in the finished assemblies among the electric compressors. If, in order to cope with such variations, accuracy is enhanced in the dimensions of the first and second terminal portions and the metal plate and also in the welding process, the manufacturing cost will increase.

Furthermore, in the electric compressor of the Publication in which the metal plate is fixed at opposite ends thereof to the first and second terminal portions, respectively, there is a fear that the metal plate between the first and second terminal portions may be deformed when the connector is connected to the external power source by pressing the first terminal portion in the axial direction of the rotary shaft toward the second terminal portion. Such deformed metal plate may be detached and out of contact with the first terminal portion and/or the second terminal portion and cause a failure in electric continuity. If any special measures are taken for the connection between the connector and the external power source, the manufacturing cost will also increase.

The present invention which has been made in view of the above circumstances is directed to providing an electric compressor that is small in size and manufactured at a lower manufacturing cost, while maintaining a high quality.

### SUMMARY OF THE INVENTION

In accordance with an aspect of the present invention, there is provided an electric compressor that includes a housing, a compression portion, an electric motor, a circuit board, and a connector. The compression portion is disposed in the housing and compresses refrigerant. The electric motor is disposed in the housing, has a rotary shaft, and drives the compression portion through the rotary shaft. The circuit board is disposed in the housing and drives and controls the electric motor. The connector is fixed to the housing and configured to electrically connect an external power source to the circuit board. The connector includes a first terminal portion extending in an axial direction of the rotary shaft and a second terminal portion extending in a radial direction of the housing and having a connecting portion through which the first terminal portion and the second terminal portion are connected to each other. The second terminal portion is adapted to elastically hold the first terminal portion at the connecting portion in such a manner as to permit the first terminal portion to move relative to the second terminal portion in the axial direction of the rotary shaft.

Other aspects and advantages of the invention will become apparent from the following description, taken in conjunction with the accompanying drawings, illustrating by way of example the principles of the invention.

### BRIEF DESCRIPTION OF THE DRAWINGS

FIG. 1 is a longitudinal sectional view of an electric compressor according to an embodiment of the present invention;

FIG. 2 is a partial enlarged sectional view of a connector of the electric compressor of FIG. 1;

FIG. 3 is a cross-sectional view of a first terminal portion of the connector of the electric compressor of FIG. 1;

FIG. 4 is a perspective view of a second terminal portion of the connector of the electric compressor of FIG. 1;

FIG. 5 is a perspective view of the second terminal portion of FIG. 4 on which a cover is mounted;

FIG. 6 is a schematic cross-sectional view showing the first terminal portion and the second terminal portion that are yet to be connected to each other;

FIG. 7 is a schematic cross-sectional view showing the first terminal portion and the second terminal portion that are connected to each other; and

FIG. 8 is a schematic cross-sectional view showing movement of the first terminal portion relative to the second terminal portion in the axial direction of a rotary shaft.

### DETAILED DESCRIPTION OF THE EMBODIMENTS

The following will describe an embodiment of the present invention with reference to the accompanying drawings.

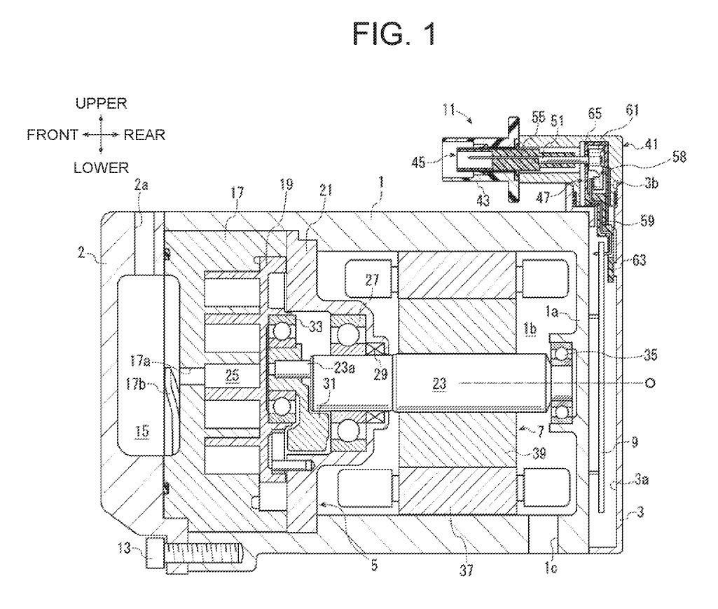

FIG. 1 shows an electric scroll compressor (hereinafter, referred to simply as the compressor) according to an embodiment of the present invention. It is to be noted that the electric scroll compressor of FIG. 1 is an example of the electric compressor of the present invention. The compressor includes a first housing member 1, a second housing member 2, an inverter cover 3, a compression portion 5, an electric motor 7, an inverter circuit board 9, and a connector 11. The first and second housing members 1, 2 and the inverter cover 3 correspond to the housing of the present invention and the inverter circuit board 9 corresponds to the circuit board of the present invention. The compressor is mounted on a vehicle (not shown) and forms part of a refrigeration circuit of an air conditioning system of the vehicle.

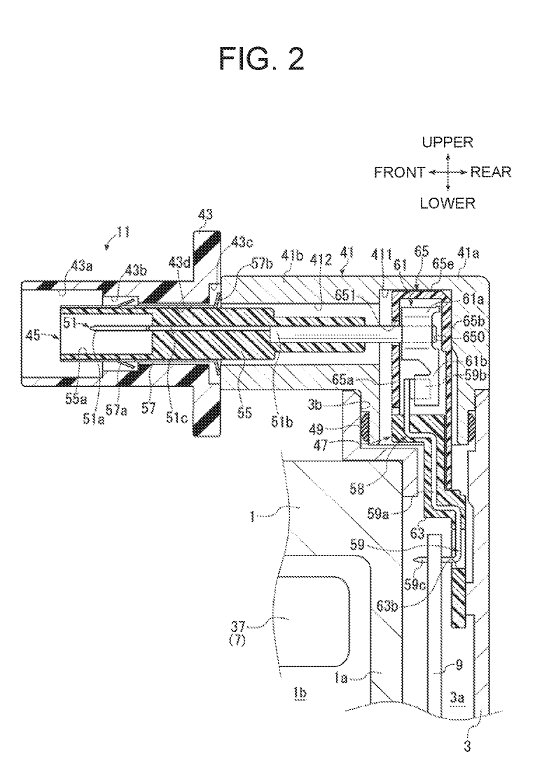

In the following description, the left side of FIG. 1 where the second housing member 2 is illustrated corresponds to the front side of the compressor and the right side of FIG. 1 where the inverter cover 3 is illustrated corresponds to the rear side of the compressor. Accordingly, the upper and lower sides of FIG. 1 correspond to the upper and lower sides of the compressor, respectively. In the subsequent FIGS. 2 to 8, the front, rear, upper, lower, right, and left are indicated in accordance with the directions specified in FIG. 1. It is, however, to be noted that the front, rear, upper and lower appearing in the drawings and the description of the present embodiment are merely exemplary. The compressor of the present invention may be mounted appropriately in various postures depending on the vehicle on which the compressor is mounted.

The first housing member 1 extends in the axial direction and has a bottomed cylindrical shape closed at the rear end thereof by a bottom wall 1a.

The first housing member 1 has therein a motor chamber 1b which also serves as a suction chamber. The first housing member 1 also has an inlet port 1c which provides communication between the motor chamber 1b and the outside of the compressor.

The second housing member 2 is fixed to the front end of the first housing member 1 with a plurality of bolts 13 to thereby form a discharge chamber 15 between the first housing member 1 and the second housing member 2. The second housing member 2 has an outlet port 2a which provides communication between the discharge chamber 15 and the outside of the compressor.

The inverter cover 3 is fixed to the rear end of the first housing member 1 to thereby form an inverter chamber 3a between the bottom wall 1a of the first housing member 1 and the inverter cover 3. The inverter cover 3 has at the upper end thereof a connecting port 3b which extends substantially in a radial direction of the inverter cover 3. The connecting port 3b is opened at the radial end thereof and is in communication with the inverter chamber 3a. An insulation sheet (not shown) is provided in the inverter chamber 3a.

The compression portion 5 includes a fixed scroll 17, a movable scroll 19, and a fixed block 21. The fixed scroll 17 is fixed to the inner peripheral surface of the first housing member 1. The movable scroll 19 is disposed in the first housing member 1 in facing relation to the fixed scroll 17. With this arrangement, the fixed scroll 17 and the movable scroll 19 are engaged with each other so as to form a compression chamber 25 therebetween. The fixed scroll 17 has a discharge port 17a which provides communication between the compression chamber 25 and the discharge chamber 15. A discharge reed valve (not shown) for opening and closing the discharge port 17a and a retainer 17b which restricts the opening of the discharge reed valve are fixed to the front end surface of the fixed scroll 17.

The fixed block 21 is fixed to the inner peripheral surface of the first housing member 1 at a position rearward of the fixed scroll 17 and the movable scroll 19. A first bearing 27 and a seal member 29 are disposed in the fixed block 21.

The electric motor 7 includes a rotary shaft 23, a stator 37, and a motor rotor 39. The rotary shaft 23 is passed through the fixed block 21, the first bearing 27, and the seal member 29 in the first housing member 1. An eccentric pin 23a is provided at the front end of the rotary shaft 23 so as to project therefrom. The eccentric pin 23a is fitted in a drive bush 31 in the fixed block 21. The rotary shaft 23 is coupled to the movable scroll 19 through the drive bush 31 and a second bearing 33. The rotary shaft 23 is supported at the rear end thereof by the bottom wall 1a of the first housing member 1 through a third bearing 35. Thus, the rotary shaft 23 is rotatable in the first housing member 1 about the axis of rotation O extending in the longitudinal direction of the compressor. The stator 37 is fixed to the inner peripheral surface of the first housing member 1 in the motor chamber 1b. The motor rotor 39 is disposed radially inward of the stator 37 and mounted on the rotary shaft 23 for rotation therewith in the motor chamber 1b.

The inverter circuit board 9 is disposed in the inverter chamber 3a in the inverter cover 3. Specifically, the inverter circuit board 9 is disposed in the inverter chamber 3a such as to extend substantially in a radial direction of the inverter cover 3. The inverter circuit board 9 is electrically connected to the stator 37 through a lead wire (not shown).

Referring to FIG. 2, the connector 11 includes a casing 41, a connector housing 43, a first connector unit 45, and a second connector unit 47. The casing 41 is made of an aluminum alloy and has a rear portion 41a and a front portion 41b. The rear portion 41a of the casing 41 extends in the vertical direction of the compressor, i.e., substantially in a radial direction of the inverter cover 3. The front portion 41b continues and extends frontward from the rear portion 41a. In other words, the front portion 41b extends substantially in the axial direction of the rotary shaft 23 shown in FIG. 1. The casing 41 having the rear portion 41a extending vertically and the front portion 41b extending axially has substantially an L-shape. As shown in FIG. 2, the casing 41 has therein a first accommodating space 411 extending in the vertical direction of the compressor and a second accommodating space 412 extending in the longitudinal or axial direction of the compressor and in communication with the first accommodating space 411. A resin grommet 49 is provided at the lower end of the rear portion 41a of the casing 41.

The connector housing 43 is made of a resin. The connector housing 43 has first to third recessed portions 43a, 43b, 43c and an insertion hole portion 43d that are formed in this order rearwardly, forming steps in the connector housing 43. The first recessed portion 43a is recessed rearward from the front end of the connector housing 43. The second recessed portion 43b is continued from the first recessed portion 43a and recessed rearward. The third recessed portion 43c is recessed frontward from the rear end of the connector housing 43. The insertion hole portion 43d extends in the longitudinal direction between the recessed portions 43b, 43c and in communication with the second and third recessed portions 43b, 43c at the front and rear ends thereof, respectively.

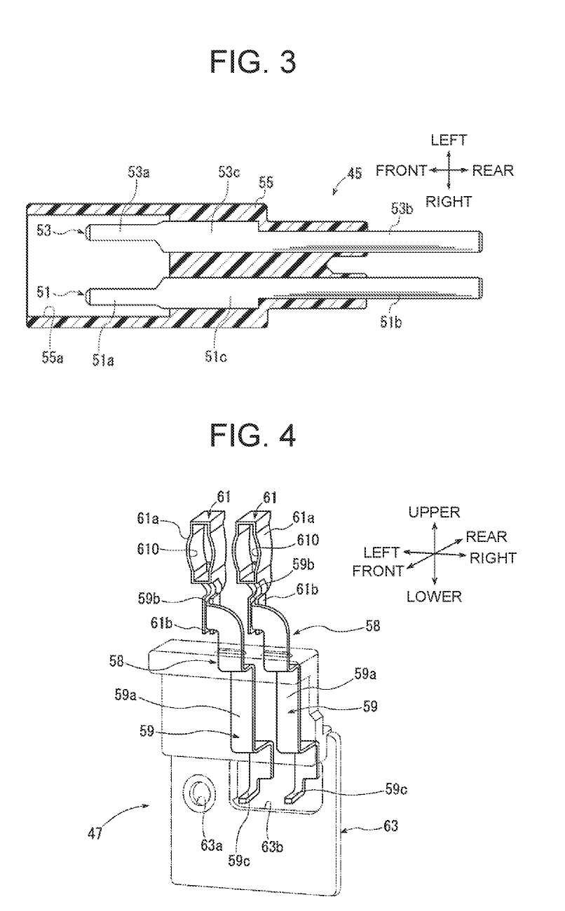

The first connector unit 45 includes two first terminal portions 51, 53 (FIG. 3), a first terminal jacket 55 (FIG. 3), and a cylindrical member 57 (FIG. 2). For the ease of description, the cylindrical member 57 is not illustrated in FIG. 3.

As shown in FIG. 1, the first terminal portion 51 is made of a metal and extends longitudinally substantially along the axial direction of the rotary shaft 23. As shown in FIG. 3, the first terminal portion 51 includes a first portion 51a, a second portion 51b, and a relay portion 51c that are integrally formed. As shown in FIG. 2, the first portion 51a forms a front end portion of the first terminal portion 51 in the axial direction of the rotary shaft 23 and extends frontward. The first portion 51a is formed in a thin plate shape having a thickness in the vertical direction. The second portion 51b forms a rear end portion of the first terminal portion 51 substantially in the axial direction of the rotary shaft 23. The second portion 51b has a different shape from the first portion 51a and is formed in a columnar or round bar shape extending axially rearward or in the direction separating away from the first portion 51a. The relay portion 51c is located between the first portion 51a and the second portion 51b. The relay portion 51c continues at the front and rear ends thereof to the first portion 51a and the second portion 51b, respectively. As is the case of the first portion 51a, the relay portion 51c is formed in a thin-plate shape having a thickness in the vertical direction. As can be understood from FIG. 3, the relay portion 51c has a width greater than that of the first portion 51a. The other first terminal portion 53 is formed in the same manner as the first terminal portion 51 and includes a first portion 53a, a second portion 53b, and a relay portion 53c. The first terminal portion 51 and the first terminal portion 53 are symmetrical to each other in shape. Therefore, the detailed description of the first terminal portion 53 is not made here.

The first terminal jacket 55 is made of an insulating resin. The first terminal jacket 55 has at the front end thereof an entrance portion 55a which is recessed rearward from the front end thereof. The first terminal jacket 55, the first terminal portion 51, and the first terminal portion 53 are integrated by insert molding, with the first terminal portion 51 and the first terminal portion 53 arranged side by side and covered by the first terminal jacket 55. Specifically, the first portions 51a, 53a and the front ends of the relay portions 51c, 53c of the first terminal portions 51, 53 are exposed in the interior of the entrance portion 55a of the first terminal jacket 55, and the rear ends of the second portions 51b, 53b of first terminal portions 51, 53 are exposed out of the first terminal jacket 55.

As shown in FIG. 2, the cylindrical member 57 is made of a metal and fitted over the outer peripheral surface of the first terminal jacket 55. The cylindrical member 57 includes a first leaf spring 57a and a second leaf spring 57b that are bent away from the first terminal jacket 55. The first and second leaf springs 57a, 57b will be described later in detail.

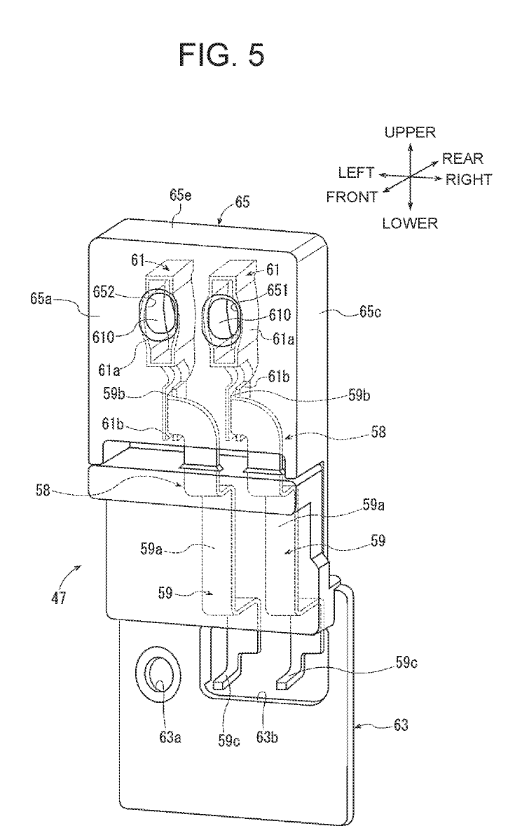

As shown in FIGS. 4 and 5, the second connector unit 47 includes two second terminal portions 58 of an identical shape, a second terminal jacket 63, and a cover 65. For the sake of description, in FIG. 4, the second terminal jacket 63 is illustrated by imaginary line, and the cover 65 is not illustrated.

Each second terminal portion 58 includes a bus bar 59 and a connecting terminal 61. The connecting terminals 61 correspond to the connecting portion of the present invention. The bus bars 59 are made of a metal plate. As shown in FIG. 2, each bus bar 59 includes a body portion 59a, a first contact portion 59b, and a second contact portion 59c. The body portions 59a extend in the vertical direction while being bent frontward or rearward at some points. As illustrated in FIG. 4, each body portion 59a is bent leftward at its upper end portion. As shown in FIG. 2, each first contact portion 59b is integrated with the upper end of the body portion 59a and extends rearward. Each second contact portion 59c is integrated with the lower end of the body portion 59a and extends frontward.

Each connecting terminal 61 is made of a metal and includes a fitting portion 61a and a joint portion 61b. The fitting portion 61a is located in the upper part of the connecting terminal 61 and has therein a fitting hole 610 extending in the longitudinal direction of the compressor. The joint portion 61b is located in the lower part of the fitting portion 61a. With the bus bar 59 pinched at the first contact portion 59b thereof by the joint portion 61b of the connecting terminal 61, the bus bar 59 and the connecting terminal 61 are welded and fixed to each other to form a second terminal portion 58. The second terminal portion 58 extends vertically in the radial direction of the inverter cover 3, as shown in FIG. 2.

The second terminal jacket 63 is made of an insulating resin and formed substantially in a rectangular shape. The second terminal jacket 63 has therethrough a bolt hole 63a extending in the thickness direction of the second terminal jacket 63 and an opening 63b extending in the thickness direction of the second terminal jacket 63 on the right of the bolt hole 63a. The second terminal jacket 63 and the bus bars 59 are formed integrally by insert molding, with the bus bars 59 arranged side by side and covered by the second terminal jacket 63. Specifically, each bus bar 59 is covered by the second terminal jacket 63 with the upper end portions of the first contact portion 59b and upper end portion of the body portion 59a exposed to the outside, and lower end portions of the second contact portions 59c and lower end portions of the body portions 59a are exposed in the opening 63b. In other words, the connecting terminals 61 that are fixed to the first contact portions 59b of the bus bars 59 are arranged side by side outside the second terminal jacket 63.

The cover 65 shown in FIGS. 5 to 8 is also made of an insulating resin. As shown in FIGS, 6 to 8, the cover 65 includes a front wall 65a, a rear wall 65b, a right wall 65c, a left wall 65d, and an upper wall 65e, which is shown in FIG. 5. The cover 65 having the above-described walls is formed substantially in a rectangular box shape having therein an accommodating chamber 650. The front wall 65a has therethrough a first insertion hole 651 and a second insertion hole 652 that are in communication with the accommodating chamber 650.

The first insertion hole 651 and the second insertion hole 652 are arranged side by side in the front wall 65a.

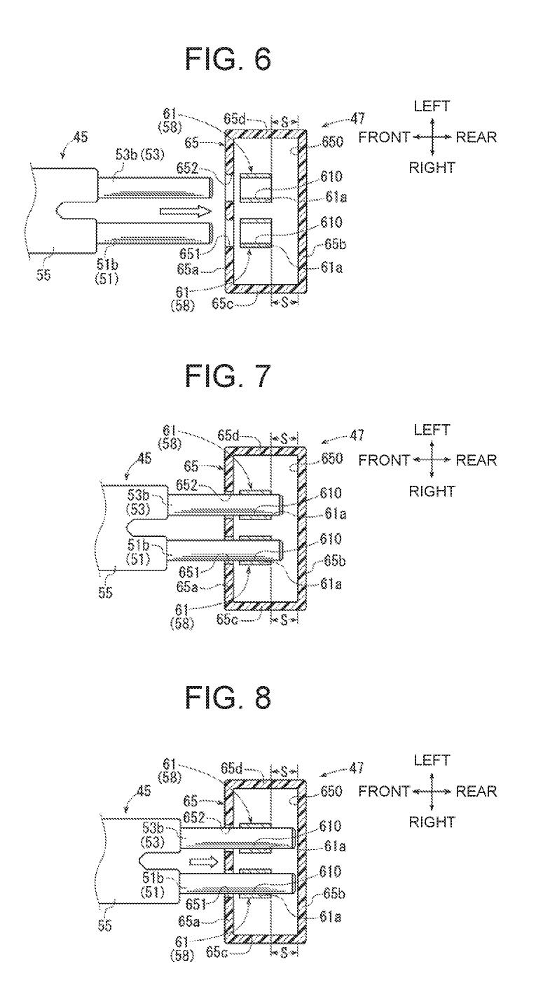

As shown in FIG. 5, the cover 65 is mounted to the top of the second terminal jacket 63, so that the first contact portion 59b, the upper end portion of the body portion 59a, and the connecting terminal 61 of each bus bar 59 are housed in the accommodating chamber 650 (FIG. 2). In this arrangement, the first insertion hole 651 is in alignment with the fitting hole 610 of the connecting terminal 61 disposed on the right side, and the second insertion hole 652 is in alignment with the fitting hole 610 of the connecting terminal 61 disposed on the left side, As shown in FIGS. 6 to 8, in the accommodating chamber 650, the rear wall 65b of the cover 65 and the connecting terminals 61 are spaced from each other having a clearance S therebetween.

The following will describe how to assemble the connector 11 with reference to FIG, 2. First, the first connector unit 45 is inserted into the insertion hole portion 43d through the third recessed portion 43c of the connector housing 43 until the front portion of the first connector unit 45 enters the first recessed portion 43a of the connector housing 43 through the second recessed portion 43b. The rear portion of the first connector unit 45 extends rearward out from the connector housing 43, and the first leaf spring 57a is located within the second recessed portion 43b. By engaging the first leaf spring 57a with the inner wall of the connector housing 43, the connector housing 43 and the first connector unit 45 are fixed to each other. The second leaf spring 57b is located within the third recessed portion 43c.

The second connector unit 47 is inserted into the first accommodating space 411 of the casing 41. In the first accommodating space 411, the second connector unit 47 is located so that the first and second insertion holes 651, 652 in the front wall 65a of the cover 65 face frontward or toward the second accommodating space 412. The lower end portion of the second connector unit 47 including the second contact portions 59c of the second terminal portion 58 extends downward out of the casing 41.

Subsequently, the rear portion of the first connector unit 45 is inserted further into the second accommodating space 412 in the longitudinal direction or the axial direction of the rotary shaft 23 so that the connector housing 43 is brought close to the front portion 41b of the casing 41. As shown in FIG. 6, the rear portion of the first connector unit 45 is moved rearward in the axial direction of the rotary shaft 23 in the second accommodating space 412 as indicated by the blank arrow and brought close to the second connector unit 47. As shown in FIG. 7, the rear ends of the second portions 51b, 53b of the first terminal portions 51, 53 are inserted into the accommodating chamber 650 through the first and second insertion holes 651, 652 in the front wall 65a of the cover 65, respectively. Then, the rear ends of the second portions 51b, 53b are inserted into the fitting holes 610, 610 of the right and left connecting terminals 61, respectively. The fitting holes 610, 610 are elastically deformed to elastically receive and hold the rear ends of the second portions 51b, 53b. At this time, the rear ends of the second portions 51b, 53b are not contacted with the rear wall 65b of the cover 65 and there is a clearance therebetween. In this way, the second terminal portions 58, 58 elastically hold the first terminal portions 51, 53 at the connecting terminals 61, 61, so that connection is established between the second terminal portions 58, 58 and the first terminal portions 51, 53 which are inserted into the second terminal portions 58, 58 from the front side thereof in the axial direction of the rotary shaft 23. Thus, the first connector unit 45 and the second connector unit 47 are electrically connected to each other.

Subsequently, the connector housing 43 and the casing 41 are fixed to each other by set screws (not shown). At this time, the second leaf spring 57b in the third recessed portion 43c is brought into contact with the front surface of the front portion 41b of the casing 41, as shown in FIG. 2. This electrical contact between the second leaf spring 57b and the casing 41 electrically shields the first terminal portions 51, 53, which helps to prevent short circuit of the first terminal portions 51, 53. Assembly of the connector 11 is thus completed.

Subsequently, in the connector 11, the lower end of the rear portion 41a of the casing 41 is inserted into the connecting port 3b of the inverter cover 3. With this connection, the grommet 49 is located within the connecting port 3b and the lower end of the second connector unit 47 is inserted into the inverter chamber 3a. Then, the second connector unit 47 is fixed to the inverter cover 3 by bolts (not shown) that are inserted into the bolt hole 63a. Accordingly, the connector 11 is fixed to the inverter cover 3 such that part of the connector 11 including part of the second connector unit 47 is located radially outward of the inverter cover 3. The casing 41 has substantially an L-shape, so that the first portions 51a, 53a are directed forward in the first recessed portion 43a of the connector housing 43.

In the inverter chamber 3a in the inverter cover 3, each bus bar 59 is soldered at the second contact portion 59c thereof to the inverter circuit board 9 to thereby establish an electrical connection between the second terminal portions 58 and the inverter circuit board 9.

The compressor is connected at the inlet port 1c (FIG. 1) to an evaporator through a pipe and at the outlet port 2a (FIG. 1) to a condenser through a pipe. The condenser is connected to the evaporator through an expansion valve. A refrigeration circuit for the vehicle air conditioning system is formed by the compressor, the evaporator, the expansion valve, the condenser, and other components. It is to be noted that the evaporator, the expansion valve, the condenser, and the pipes are not illustrated in the drawings.

In the compressor which has been configured as described above, the first portions 51a, 53a of the first terminal portions 51, 53 are connected to an external connector (not shown) which is inserted into the entrance portion 55a of the first terminal jacket 55. The first portions 51a, 53a of the first terminal portions 51, 53 are connected to a battery (not shown) as an external power source through the external connector connected therewith. With this connection, the connector 11 electrically connects the battery and the inverter circuit board 9 through the first terminal portions 51, 53 and the second terminal portions 58, 58. In this state, the inverter circuit board 9 supplies electric power to the stator 37 to drive and control the electric motor 7, which in turn rotates the rotary shaft 23 of the electric motor 7. With the rotation of the rotary shaft 23, the compression portion 5 is operated to take in the refrigerant that has flowed from the evaporator to the motor chamber 1b into the compression chamber 25 for compression of the refrigerant. The compressed refrigerant is discharged into the discharge chamber 15 and delivered to the condenser for circulation flowing through the expansion valve and the evaporator and back to the compressor, thereby cooling the air in the vehicle interior.

In the compressor of the present embodiment, the second portions 51b, 53b of the first terminal portions 51, 53 are inserted into the fitting holes 610, 610 of the connecting terminals 61, 61 in the axial direction of the rotary shaft 23 and elastically held in the fitting holes 610, 610. In other words, the first terminal portions 51, 53 are connected to the second terminal portions 58, 58 through the connecting terminals 61, 61 that elastically hold the first terminal portions 51, 53. Unlike the compressor in which the first terminal portions are connected to the second terminal portions by welding, the compressor according to the present embodiment does not require any tool for welding and therefore, there is no need of providing a space for welding work in the compressor. According to the compressor of the present embodiment, the size of the connector 11 can be reduced.

Furthermore, in the accommodating chamber 650 in the cover 65, the rear wall 65b and the connecting terminals 61 are spaced from each other having the clearance S therebetween, as shown in FIGS. 6 to 8. This clearance S allows the second portions 51b, 53b to move substantially in the axial direction of the rotary shaft 23 through the fitting holes 610, 610. In other words, the connecting terminals 61, 61 permit the first terminal portions 51, 53, which are in a connected state with the second terminal portions 58, 58, respectively, to move relative to the second terminal portions 58, 58 substantially in the axial direction of the rotary shaft 23 through the fitting holes 610, 610. Therefore, any variation in the dimension of the first terminal portions 51, 53 and the second terminal portions 58, 58 are absorbed when connecting the first terminal portions 51, 53 to the second terminal portions 58, 58 or when connecting the first connector unit 45 to the second connector unit 47. With this configuration, the dimensional variation in the first terminal portions 51, 53 and the second terminal portions 58, 58 and hence the dimensional variation in the assemblies of the first terminal portions 51, 53 and the second terminal portions 58, 58 are reduced without particularly enhancing the accuracy in the dimension of the terminals 51, 53, 58, 58 and also in the connecting work of the first connector unit 45 to the second connector unit 47.

According to the compressor of the present embodiment, in connecting the first portions 51a, 53a to the battery through an external connector, the first connector unit 45 is inserted into the second connector unit 47 substantially in the axial direction of the rotary shaft 23, as indicated by the blank arrow in FIG. 8. In this state, the second portions 51b, 53b held by the fitting holes 610, 610 are movable further rearward in the same axial direction of the rotary shaft 23 in the accommodating chamber 650. In the compressor of the present embodiment in which the first terminal portions 51, 53 are allowed to move in the axial direction of the rotary shaft 23 relative to the second terminal portions 58, 58, the first terminal portions 51, 53 are prevented from being deformed between the battery and the second terminal portions 58, 58 when connecting the connector 11 to the battery. Therefore, the connection between the connector 11 and the battery is facilitated.

According to the compressor of the present embodiment, the connector 11 is fixed to the inverter cover 3 such that part of the connector 11 including part of the second connector unit 47 is located radially outward of the inverter cover 3. Therefore, the dimension of the compressor in the axial direction is reduced, as compared with the configuration in which the connector 11 is fixed externally to the rear end of the inverter cover 3 in the axial direction thereof. Furthermore, the connector 11 having an L-shape due to the L-shaped casing 41 helps to prevent an increase in the dimension of the compressor in the radial direction.

Therefore, the compressor according to the present embodiment is manufactured smaller in size and at a lower cost while maintaining the desired high quality.

Although the present invention has been described in accordance with above the embodiment, the present invention should not be limited to the above embodiment and may variously be modified within the scope of the present invention.

For example, the compressor according to the present invention is not limited to an electric scroll compressor, and other types of compressors, such as an electric vane compressor may be employed.

In the above embodiment, the first portion 51a, the second portion 51b, and the relay portion 51c of the first terminal portion 51 are formed integrally. However, alternatively, the first terminal portion 51 may be configured such that the first portion 51a and the relay portion 51c are formed integrally and the second portion 51b is formed separately as an individual part and then the second portion 51b is joined to the integrated body of the first portion 51a and the relay portion 51c to form the first terminal portion Si In another alternative, the first portion 51a and the second portion 51b may be formed integrally as the first terminal portion 51 without providing the relay portion 51c between them. The same also applies to the first terminal portion 53.

The second terminal portions 58 in the above embodiment have the same configuration. However, the bus bars 59 may be formed in different configurations so that the second terminal portions 58 have different configurations.

The present invention is applicable to an air conditioning system of a vehicle and the like.

What is claimed is:

1. An electric compressor comprising:
a housing;
a compression portion that is disposed in the housing and compresses refrigerant;
an electric motor that is disposed in the housing, has a rotary shaft, and drives the compression portion through the rotary shaft;
a circuit board that is disposed in the housing and drives and controls the electric motor; and
a connector that is fixed to the housing and configured to electrically connect an external power source to the circuit board, wherein
the connector includes a first terminal portion extending in an axial direction of the rotary shaft and a second terminal portion extending in a radial direction of the housing and having a connecting portion through which the first terminal portion and the second terminal portion are connected to each other, and
the second terminal portion is adapted to elastically hold the first terminal portion at the connecting portion in such a manner as to permit the first terminal portion to move relative to the second terminal portion in the axial direction of the rotary shaft.

2. The electric compressor according to claim 1, wherein
the first terminal portion includes a first portion and a second portion,
the first portion forms one end portion of the first terminal portion in the axial direction and is configured to be connected to the external power source,
the second portion forms the other end portion of the first terminal portion in the axial direction and extends axially in a direction separating away from the first portion, the first portion and the second portion being formed integrally, and
the connecting portion has a fitting hole adapted to permit the second portion of the first terminal portion to be inserted therethrough in the axial direction and elastically hold the second portion.

3. The electric compressor according to claim 1, wherein the connector is fixed to the housing such that part of the connector is located radially outward of the housing.
